(19) United States
(12) Patent Application Publication
(10) Pub. No.: US 2016/0350429 A1
(43) Pub. Date: Dec. 1, 2016

(54) SYSTEM AND METHOD FOR MATCHING, QUALIFYING AND DISSEMINATING REAL ESTATE INFORMATION

(71) Applicant: Keith Douglas TRIPPIE, Manassas, VA (US)

(72) Inventor: Keith Douglas TRIPPIE, Manassas, VA (US)

(21) Appl. No.: 15/156,542

(22) Filed: May 17, 2016

Related U.S. Application Data
(60) Provisional application No. 62/166,477, filed on May 26, 2015.

(51) Int. Cl. G06F 17/30; G06Q 50/16; H04L 29/08

(52) U.S. Cl. CPC G06F 17/30867; H04L 67/18; G06F 17/30241; G06Q 50/163

(57) ABSTRACT

A system for determining an ideal location to relocate, purchase or lease a building, to is provided. The system embodies a computer-implemented method providing a relocation application to a user for installation on a remote user computer, wherein the relocation application prompts the user to select a general area of interest on a map display; prompting the user to enter search criteria comprising characteristics of a local community; displaying a plurality of results on a map display responsive to the entered search criteria, wherein each result is a location on the map display within the general area of interest, and wherein the plurality of results can be exported to a wireless device associated with a real estate agent.

### CROSS-REFERENCE TO RELATED APPLICATION

This application claims the benefit of priority of U.S. provisional application number 62/166,477, filed 26 May 2015, the contents of which are herein incorporated by reference.

### BACKGROUND OF THE INVENTION

The present invention relates to systems and methods for qualifying and disseminating information, and, more particularly, to a system and method for matching, qualifying and disseminating information pertaining to an ideal location to relocate to or lease or acquire a physical location asset.

No real estate website or mobile application exists today that helps a person plan a move, and match their unique and personal needs to the new town, county, or state they are moving to. Moving is very stressful for people and time extensive; and can lead to bad investments. Real estate agents waste time driving customers to multiple communities, reducing their effectiveness. Real estate agents are limited in what they can advise house buyers or apartment renters; leaving buyers and renters at risk to bad decisions as they do not have all the information about the community before they make a decision. No real estate app or website addresses the first step in the moving process which includes where to live. Rather, they only focus on the type of home or dwelling. Additionally, commercial real estate investors do not have a simple way to analyze the best area to either purchase or rent a building; adding risk to their investment.

Under the Federal Fair Housing Act, many acts are unlawful if based upon race, color, religion, sex, national origin, handicap, or familial status, including refusing to rent or sell residential property, and are rightfully punishable. The unintended consequences of such laws, however, is self-censorship on the part of the real estate agent regarding questions relating to a neighborhood's composition. To wit, the Civil Rights and Fair Housing guidelines recommend that since “it's difficult to prove or deny discriminatory intent, an agent should avoid all statements regarding the racial or ethnic composition of a neighborhood.” Well, what if a prospective buyer is interested in a specific ethnic makeup of a neighborhood because they desire such a makeup? Additionally, with limited consumer-relevant market information, real estate agents are far less productive and have extended sales cycles, negatively impacting their business

As can be seen, there is a need for a system and method for qualifying and disseminating information pertaining to an ideal location to relocate to.

### SUMMARY OF THE INVENTION

In one aspect of the present invention, a computer-implemented method for qualifying and disseminating consumer and commercial real estate information includes providing a relocation application to a user for installation on a remote user computer; prompting the user to select a general area of interest on a map display of the relocation application; prompting the user to enter search criteria comprising characteristics of a local community; and displaying a plurality of results on a map display responsive to the entered search criteria, wherein each result is a location on the map display within the general area of interest.

In another aspect of the present invention, the computer-implemented method for qualifying and disseminating real estate information further includes the user defining the general area of interest by a selected radii; prompting the user to provide a rank for each of the search criteria, wherein each of the plurality of results are identified by an associated sweet-spot pin, wherein each sweet-spot pin is color-coded in response to the ranking of each search criteria, and wherein the plurality of search criteria includes at least one of proximity to healthcare, proximity to schools, crime rates, commute time, household income, house values, demographic, entertainment and social facilities, restaurants, and makeup of an associated general area of interest, and further including exporting the plurality of results to a wireless device associated with a commercial or consumer real estate agent.

These and other features, aspects and advantages of the present invention will become better understood with reference to the following drawings, description and claims.

### BRIEF DESCRIPTION OF THE DRAWINGS

FIG. 1 is a flow chart of an exemplary embodiment of the present invention;

FIG. 2 is a flow chart of an exemplary embodiment of the present invention;

FIG. 3A is a schematic view of an exemplary embodiment of the present invention;

FIG. 3B is a schematic view of an exemplary embodiment of the present invention;

FIG. 3C is a schematic view of an exemplary embodiment of the present invention;

FIG. 3D is a schematic view of an exemplary embodiment of the present invention;

FIG. 3E is a schematic view of an exemplary embodiment of the present invention;

FIG. 3F is a schematic view of an exemplary embodiment of the present invention; and

FIG. 3G is a schematic view of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, the present invention includes a system for determining an ideal location to relocate to that embodies a computer-implemented method providing a relocation application to a user for installation on a remote user computer, wherein the relocation application prompts the user to select a general area of interest on a map display; prompting the user to enter user specific search criteria comprising characteristics of a local community; displaying a plurality of results on a map display responsive match to the entered search criteria, wherein each result is a location on the map display within the general area of interest, and wherein the plurality of results can be saved and exported to a wireless device associated with a real estate agent, data buyer, etc. as customer intent data; currently unavailable in the marketplace

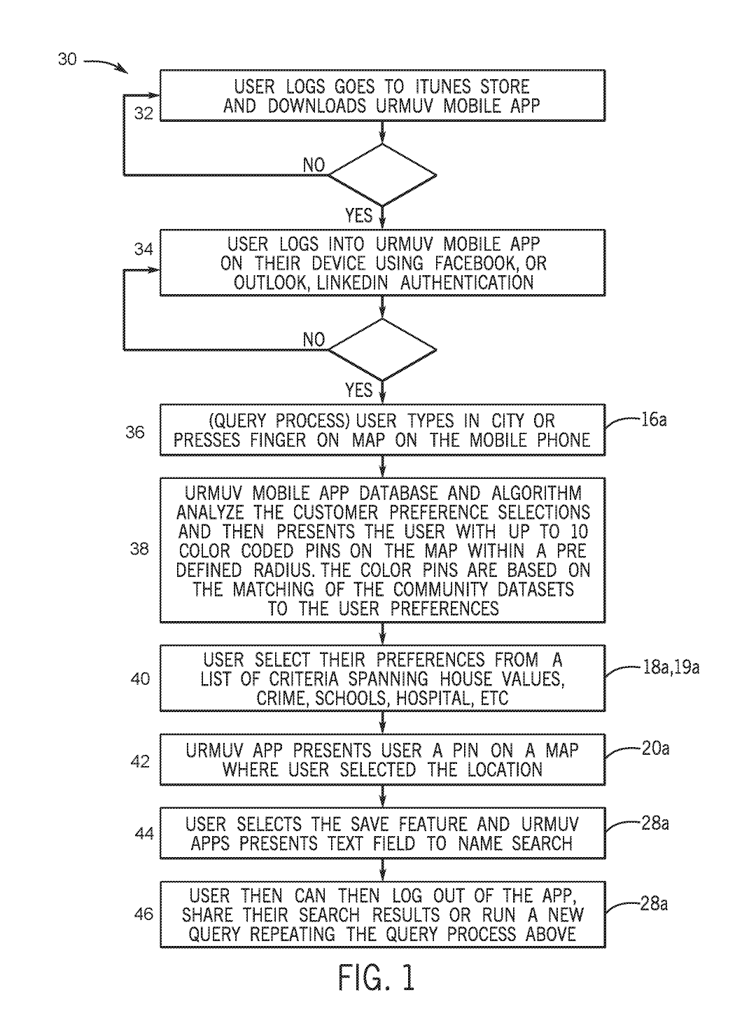

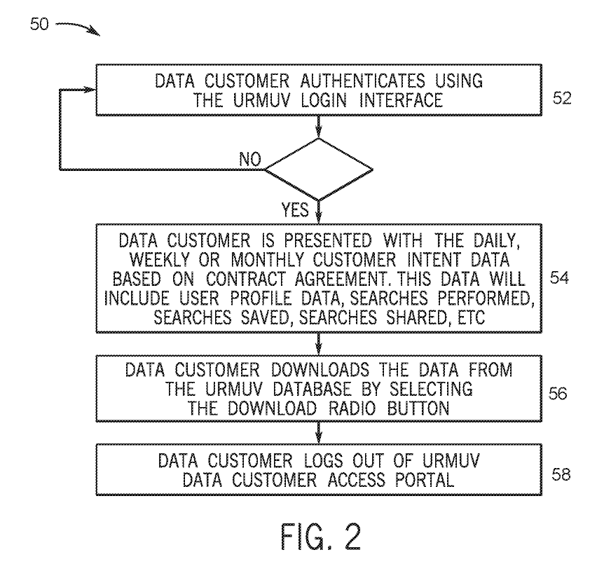

Referring to FIGS. 1 through 3G, the present invention may include at least one computer 12 with a user interface. The computer 12 may include any computer 12 including, but not limited to, a desktop, laptop, and smart device, such as, a tablet and smart phone. The computer 12 includes a program product including a machine-readable program code for causing, when executed, the computer 12 to perform steps. The program product may include software which may either be loaded onto the computer 12 or accessed by the computer 12. The loaded software may include an application on a smart device. The software may be accessed by the computer 12 using a web browser. The computer 12 may access the software via the web browser using the internet, extranet, intranet, host server, internet cloud and the like.

The present invention includes a mobile application 10 that helps people moving match their most important personal criteria to their new community. The present invention includes an easy to use mobile application 10 that includes information about hospitals, schools, commute time, household income, social economic, crime statistics, entertainment, restaurant and house values. Using the application, the user can easily, from a map display 14, select the quality values and radius of search of that information that is most important to them. The mobile application 10 quickly performs a proprietary matching algorithm to identify the “Sweet-spot” within the area. Users of the mobile application 10 can then receive a list of Sweet-spot on a map display 14 that either match all of their criteria or a close match of their criteria with easily understood Green/Yellow/Red based on the community characteristics match to the user's criteria pin 22s. Users can then click on the Sweet-spot Pin 22 on the map display 14 to drill down for extensive information about the community. Users can save both their search results and search criteria that easily allow the user to better match their needs to their new community. After they have identified a few communities that best meet their needs, they can then go to any of the other real estate company and/ or application that exists today which provides specific building, warehouse, house or apartment information.

The present invention is the only mobile application 10 that allows users to select person specific criteria (hospital ratings, school ratings, crime rates, commute times, etc.) and how much they prioritize each criteria and rank the criteria. The present invention includes a proprietary matching algorithm which quickly performs analysis and provides easy to understand visual cues and extensive data about a community based on the user preferences. The present invention significantly helps reduce the risk of wasting time and money by the person moving. The present invention allows users to quickly identify characteristics of a community that directly match to the user's needs, and thereby greatly increases the user's chance of moving to the right community.

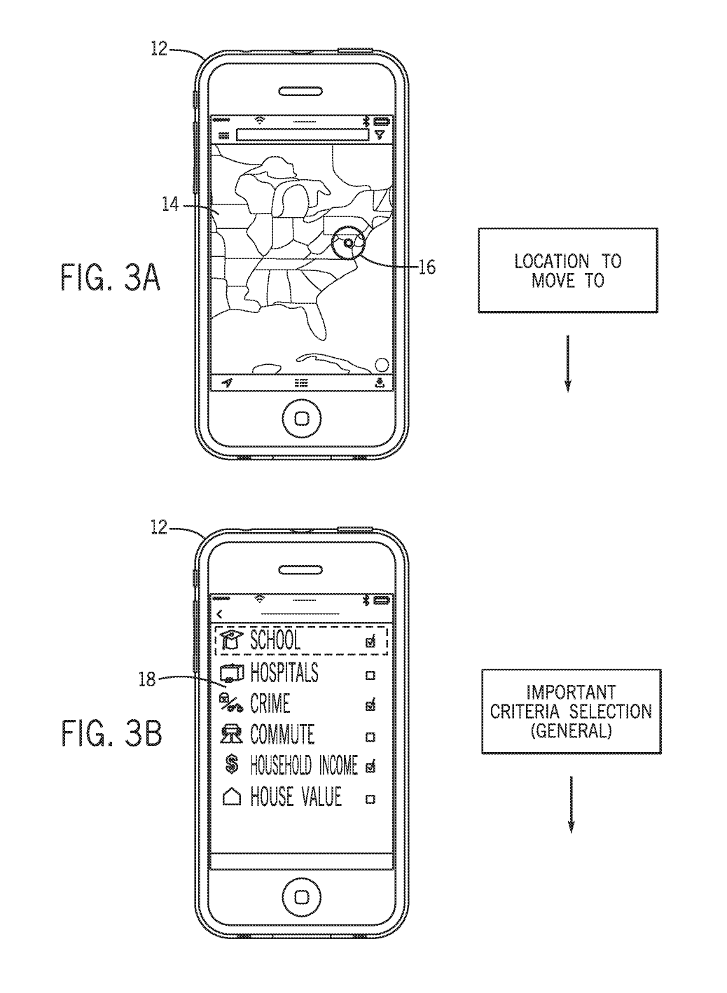

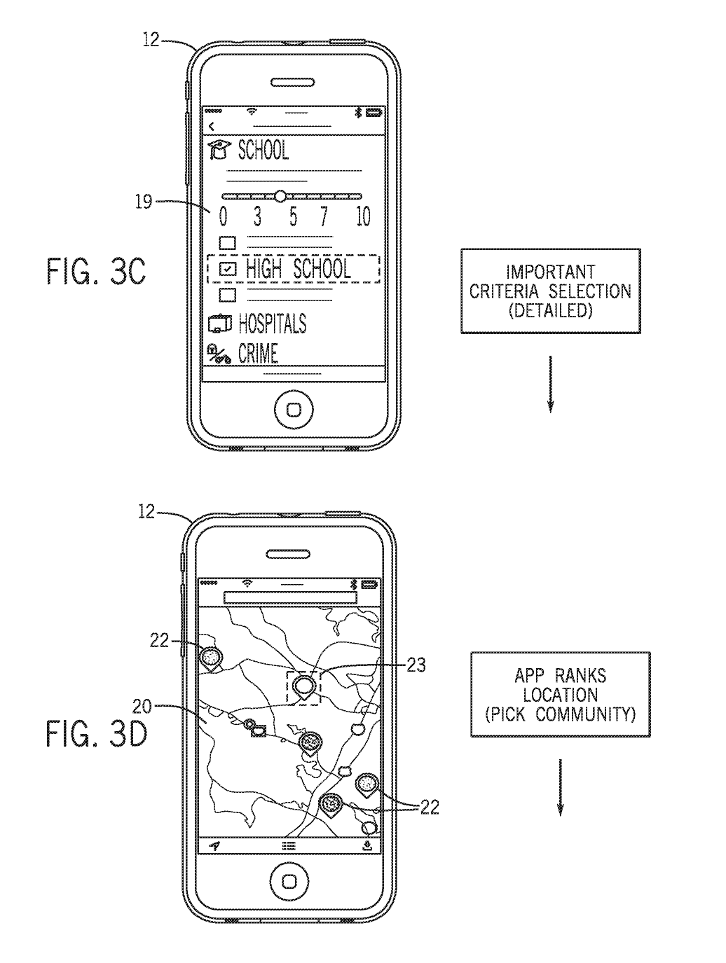

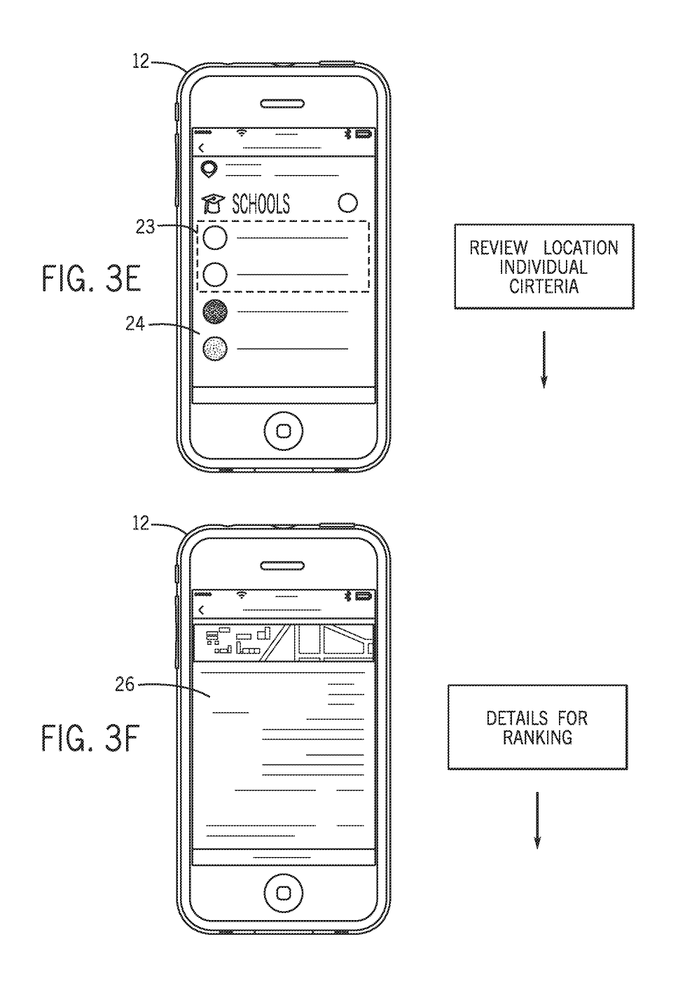

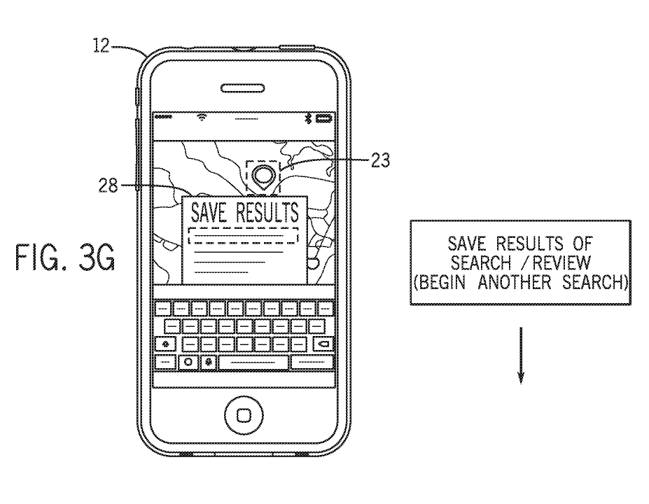

The mobile application 10 of the present invention allows for ease of download and registration. The user's may easily select where they are moving to a new location by either touching a point on a map display 14, or typing 22 in a city and/or zip code. The present invention allows users to select a radius of 5-50 miles from their location point. Through a general criteria selection display 18, users can then select from multiple criteria: hospitals, schools, crime rates, commute time, household income, house values, and the like, as illustrated in FIG. 3B. The user can adjust their personal settings and preferences by each criterion. Furthermore, each user may provide more detailed criteria and/or rank the importance of each criteria through a detailed criteria selection display 19, as illustrated in FIG. 3C. The present invention then allows the user to hit submit and see a map display 14 which includes pins 22 or “sweet-spot”. Each sweet-spot or pin 22 may be color coded, green/yellow or red and the color coding is based on the community match percentage to the user's unique needs. The user can then click on each pin 22. The pin 22 opens up and displays each search criteria and the color coded match to the user preference based on the unique and proprietary matching algorithm. The user can then select one or all criteria and narrow down the search to receive extensive information about school ratings, crime rates to national average, hospital ratings, commute time variance to their preference, can view other information on the map display 14 including restaurants, entertainment, museums, and the like. The map display 14 may include zoom capabilities 20, as illustrated in FIG. 3D. The user can then save both their search results and name as well as their search criteria, allowing users to select the same search criteria across different cities or points on a map display 14.

The mobile software application works in concert across its multiple elements. The software captures data from the user, via easy to use selection features. Based on how the user selects each feature from the selection criteria and the rankings of each criterion, the proprietary algorithm presents the user with color coded pins 22 which factor in the user choice and information in the applications database about the selected community. The algorithm's formula may decide which color the pin 22 is coded. The user can then select the pin 22 and the selected criteria to find a wealth of information about the location. In certain embodiments, the mobile application 10 may enable the user to identify and save preferred pins 23, as illustrated in FIGS. 3D and 3E. The user can then save the search results to go back and review later, change the search criteria based on the results of the original search or can save the search criteria and use that against other locations on a map display 14 to create a new saved search option. In certain embodiments, the mobile application 10 may provide a location review display 24 and saved results display 28 of previously unsaved and saved search results, respectively, as illustrated in FIGS. 3E and 3G. In certain embodiments, the mobile application 10 may provide a rankings detail display 26 of the previous search result(s), as illustrated in FIG. 3F.

All transactions may be recorded for analytics and analysis to enhance the application in future releases, as well as analysis by real estate industry professionals. The mobile application 10 may be shared with a real estate agent via exportation, or the like, via a wireless device associated with the real estate agent. Whereby the commercial or consumer real estate agent need not engage in impermissible composition of a neighborhood discussions, since they can use the exported results from their wireless device to ascertain the quality of the relevant customer intent information.

A person would use the mobile application 10 as the first step 30 in the moving process. A person has various reasons why they need to move; retirement, divorce, new job, job transfer, etc. The user may access the application, and follow the very user friendly interface to get started, in step 32. Almost every American has a mobile app, and knows how to navigate apps that have map display 14 as part of their solution, including logging on and authentication using social media, Facebook™, LinkedIn™, or the like, in step 34. The present invention provides simple user interface and once the user completes the first transaction, they will easily be able to repeat the process over and over again. The first transaction may by a query process wherein the user types in a city or presses a finger on the map display 14 via a query process step 16a, in step 36. The user the present invention because it is the only mobile application 10 that helps them find and match the right community based on their individual needs. The user gets to select their preferences via user preference steps 18a and 19a, in step 40, and the algorithm does the work for the user. The results of their search are presented with pins 22 on the map display 14 that are color coded so users know which of their searches best meet their unique needs, in steps 38 and 42. The user can then drill down on each pin 22 and search criteria to get a lot of information they did not have which is very helpful for the user as they do not know much about the area they are moving to. Once the user finds search results they want to save, the present invention allows them to save the results, and name them for easy call up reference in the future, in step 44. The user can also save the search criteria they have used and apply that onto a different city or location on a map display 14. This is a user friendly feature to save the user time. Then the user may log out of the mobile application 10 using a saving and logging out step 28a, in step 46.

A workflow design 50 may include a data customer authentication using the present invention's login interface, in step 52. In step 54, data customer may be presented with the daily weekly or monthly customer intent data based on contract agreement. Such data may include user profile data, searches performed, searches saved, searches shared, and the like. In step 56, data customer downloads the data from the present invention's database by selecting the download radio button. Then in step 58, the data customer logs out of the present invention customer access portal.

All the above features provide a unique in the marketplace application that would benefit individuals moving, investors prior to making a building purchase or leasing a building. Once they have identified the right sweet-spot based on their preference, the user can then go to a real estate agent with their specified neighborhood compositions of interest.

The computer 12-based data processing system and method described above is for purposes of example only, and may be implemented in any type of computer 12 system or programming or processing environment, or in a computer 12 program, alone or in conjunction with hardware. The present invention may also be implemented in software stored on a computer 12-readable medium and executed as a computer 12 program on a general purpose or special purpose computer 12. For clarity, only those aspects of the system germane to the invention are described, and product details well known in the art are omitted. For the same reason, the computer 12 hardware is not described in further detail. It should thus be understood that the invention is not limited to any specific computer 12 language, program, or computer 12. It is further contemplated that the present invention may be run on a stand-alone computer 12 system, or may be run from a server computer 12 system that can be accessed by a plurality of client computer 12 systems interconnected over an intranet network, or that is accessible to clients over the Internet. In addition, many embodiments of the present invention have application to a wide range of industries. To the extent the present application discloses a system, the method implemented by that system, as well as software stored on a computer 12-readable medium and executed as a computer 12 program to perform the method on a general purpose or special purpose computer 12, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A computer-implemented method for qualifying and disseminating real estate information, comprising:
providing a relocation application to a user for installation on a remote user computer;
prompting the user to select a general area of interest on a map display of the relocation application;
prompting the user to enter unique search criteria comprising characteristics of a local community; and
displaying a plurality of results on a map display user specific matching, responsive to the entered search criteria, wherein each result is a location on the map display within the general area of interest.

2. The method of claim 1, wherein the user may define the general area of interest by a selected radii.

3. The method of claim 2, further including prompting the user to provide a rank for each of the search criteria.

4. The method of claim 3, wherein each of the plurality of matching results are identified by an associated sweet-spot pin.

5. The method of claim 4, wherein each sweet-spot pin is color-coded in response to the ranking of each search criteria.

6. The method of claim 5, wherein the plurality of search criteria includes at least one of proximity to hospitals, proximity to schools, crime rates, commute time, household income, house income, restaurants, social and entertainment locations and demographic makeup of an associated general area of interest.

7. The method of claim 6, further including exporting the plurality of results to a wireless device associated with a real estate agent.
